(19) United States
(12) Patent Application Publication
(10) Pub. No.: US 2013/0052496 A1
(43) Pub. Date: Feb. 28, 2013

(54) SECONDARY BATTERY AND SECONDARY BATTERY MODULE

(71) Applicant: Jung-Yeop Han, Yongin-si (KR)

(72) Inventor: Jung-Yeop Han, Yongin-si (KR)

(73) Assignee: Samsung SDI Co., Ltd., Yongin-si (KR)

(21) Appl. No.: 13/591,510

(22) Filed: Aug. 22, 2012

(30) Foreign Application Priority Data
Aug. 24, 2011 (KR) 10-2011-0084827

(51) Int. Cl. H01M 2/10; H01M 10/50

(52) U.S. Cl. 429/72; 429/96; 429/99

(57) ABSTRACT

A secondary battery and a secondary battery module. The secondary battery includes: a battery unit; and a frame case that supports the battery unit and has a first side portion and a second side portion which are opposite to each other and on which first and second spacers are respectively formed, wherein the first and second spacers have asymmetric dimensions. Accordingly, the secondary battery and the secondary battery module include a misassembly-preventing mechanism.

### RELATED APPLICATIONS

This application claims the benefit of Korean Patent Application No. 10-2011-0084827, filed on Aug. 24, 2011, in the Korean Intellectual Property Office, the disclosure of which is incorporated herein in its entirety by reference.

### BACKGROUND

1. Field

One or more embodiments of the present invention relate to a secondary battery and a secondary battery module.

2. Description of the Related Art

Secondary batteries are used in a wide range of industrial applications due to their advantages. Secondary batteries are widely used as energy sources of mobile electronic devices such as digital cameras, cellular phones, or laptop computers. Secondary batteries are also spotlighted as energy sources for hybrid electric vehicles or the like, which are suggested as solutions to air pollution caused by existing combustion engines using fossil fuels such as gasoline or diesel.

### SUMMARY

One or more embodiments of the present invention include a secondary battery and a secondary battery module including a mechanism for preventing misassembly of a secondary battery.

Additional aspects will be set forth in part in the description which follows and, in part, will be apparent from the description, or may be learned by practice of the presented embodiments.

According to one or more embodiments of the present invention, a secondary battery includes: a battery unit; and a frame case that supports the battery unit and has a first side portion and a second side portion which are opposite to each other and on which first and second spacers are respectively formed, wherein the first and second spacers have asymmetric dimensions.

The first and second spacers may protrude perpendicularly to a main surface of the frame case.

The first and second spacers may protrude to different thicknesses from the frame case.

The frame case may support the battery unit due to the frame case having a frame shape extending along an edge of the battery unit.

A plurality of sub-members of the first and second spacers may be arranged to have isolated shapes along the opposite first and second side portions of the frame case.

The first and second spacers may be arranged in two or more columns along each of the first and second side portions.

The battery unit may include a main body, and first and second lead tabs extending out of the main body, wherein the first and second lead tabs extend to the outside through a third side portion of the frame case.

The first and second spacers may be respectively formed on the first and second side portions of the frame case adjacent to the third side portion of the frame case.

The frame case may include first and second frame cases that are coupled to each other to face each other with the battery unit between the first and second frame cases.

The first and second frame cases may be formed to have frame shapes that hold an edge of the battery unit.

Each of the first and second frame cases may include an opening through which a central portion of the battery unit is exposed.

First and second spacers having asymmetric dimensions may be disposed on opposite sides of the first frame case, and first and second spacers having asymmetric dimensions are disposed on opposite sides of the second frame case.

The secondary battery may further include a heat-dissipating member that is disposed along with the battery unit between the first and second frame cases.

According to another aspect of the present invention, a secondary battery module includes a plurality of secondary batteries that are arranged adjacent to one another, wherein each of the plurality of secondary batteries includes: a battery unit; and a frame case that supports the battery unit and has a first side portion and a second side portion which are opposite to each other and on which first and second spacers are respectively formed, wherein the first and second spacers have asymmetric dimensions.

The first and second spacers may protrude to different thicknesses from the frame case.

The first spacer and the second spacer may be assembled to contact each other between adjacent secondary batteries.

The first and second spacers contacting each other may form an airflow passage.

The frame case may be formed to have a frame shape that holds an edge of the battery unit, and comprises an opening through which a central portion of the battery unit is exposed.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view illustrating a secondary battery according to an embodiment of the present invention;

FIG. 2 is a perspective view illustrating a state where the secondary battery of FIG. 1 is assembled;

FIG. 3 is a perspective view illustrating a battery unit of the secondary battery of FIG. 1;

FIGS. 4 and 5 are perspective views illustrating first and second frame cases of the secondary battery of FIG. 1;

FIG. 6 is an enlarged perspective view illustrating the first frame case of FIG. 4;

FIG. 7 is a cross-sectional view taken along line VII-VII of FIG. 4;

FIGS. 8 and 9 are cross-sectional views for explaining a misassembly-preventing mechanism;

FIG. 10 is a side perspective view for explaining an airflow passage; and

FIG. 11 is an exploded perspective view illustrating a secondary battery module in which a plurality of the secondary batteries of FIG. 2 are electrically joined together, according to an embodiment of the present invention.

### DETAILED DESCRIPTION

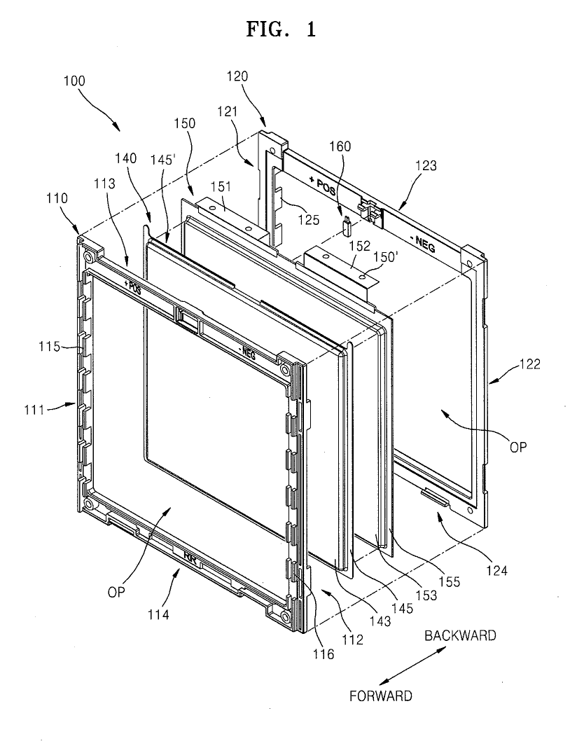

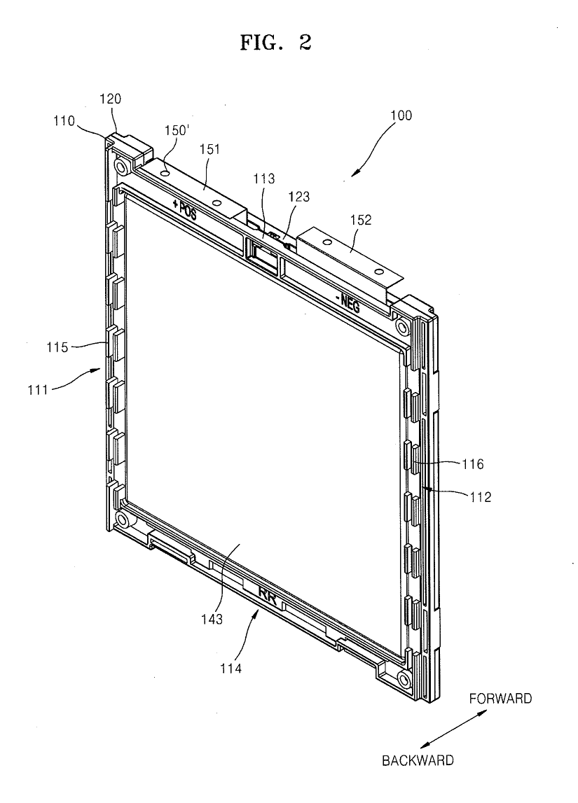

The present invention will now be described more fully with reference to the accompanying drawings, in which exemplary embodiments of the invention are shown. FIG. 1 is an exploded perspective view illustrating a secondary battery 100 according to an embodiment of the present invention. FIG. 2 is a perspective view illustrating a state where the secondary battery 100 of FIG. 1 is assembled.

Referring to FIG. 1, the secondary battery 100 includes a battery unit 150 and first and second frame cases 110 and 120 that support the battery unit 150. As described below, the first and second frame cases 110 and 120 may support the battery unit 150 because the first and second frame cases 110 and 120 have frame shapes extending along an edge of the battery unit 150.

The battery unit 150 may include, for example, a lithium-ion battery. The battery unit 150 includes a main body 153 and a flange portion 155, and first and second lead tabs 151 and 152 that are electrically connected to the main body 153 and extend out of the main body 153.

The battery unit 150 is structurally supported by the first and second frame cases 110 and 120. The battery unit 150 and the first and second frame cases 110 and 120 may be assembled to face each other. For example, the first and second frame cases 110 and 120 may be assembled to face each other with the battery unit 150 therebetween.

The first and second frame cases 110 and 120 may be formed to have quadrangular frame shapes having an opening OP at a central portion is formed. For example, the first and second frame cases 110 and 120 may be formed to have substantially regular square frame shapes or quadrangular frame shapes.

The first and second frame cases 110 and 120 firmly fix the battery unit 150 by surrounding and tightening the flange portion 155 of the battery unit 150, and expose the main body 153 of the battery unit 150 to the outside through the opening OP. That is, since the main body 153 on which heat generated by the battery unit 150 is concentrated is exposed between the first and second frame cases 110 and 120, heat dissipation may be promoted.

For example, the flange portion 155 of the battery unit 150 tightened between the first and second frame cases 110 and 120 may correspond to an edge of the battery unit 150 formed by outwardly extending a spare exterior material sealing an electrode assembly (not shown). In this case, even when the flange portion 155 of the battery unit 150 is compressed between the first and second frame cases 110 and 120, damage to the electrode assembly does not occur. Meanwhile, since the main body 153 of the battery unit 150 including the electrode assembly is exposed from the first and second frame cases 110 and 120, heat dissipation may be promoted. However, as described below, since a heat-dissipating member 140 may be attached to the battery unit 150, the main body 153 of the battery unit 150 may not be exposed to the outside of the secondary battery 100.

The first and second frame cases 110 and 120 may be formed to have quadrangular frame shapes including first through fourth side portions 111, 112, 113, 114, 121, 122, 123, and 124. In detail, the first and second frame cases 110 and 120 may include the first and second side portions 111, 112, 121, and 122 which extend in parallel and on which first and second spacers 115 and 116 are formed, and the third and fourth side portions 113, 114, 123, and 124 which extend in parallel between the first and second side portions 111, 112, 121, and 122.

For example, the third side portions 113 and 123 of the first and second frame cases 110 and 120 may be formed at a side where the first and second lead tabs 151 and 152 of the battery unit 150 extend, and the first and second lead tabs 151 and 152 of the battery unit 150 may extend to the outside of the first and second frame cases 110 and 120 through the third side portions 113 and 123 of the first and second frame cases 110 and 120.

The first and second frame cases 110 and 120 may be formed of an insulating resin material, for example, a polymer resin material such as poly(p-phenylene sulphide (PPS), in order to be insulated from the first and second lead tabs 151 and 152.

The heat-dissipating member 140 along with the battery unit 150 may be disposed between the first and second frame cases 110 and 120. The heat-dissipating member 140 may be a substantially plate-shaped member which covers one surface of the battery unit 150. The heat-dissipating member 140 may be formed of a metal material having high thermal conductivity, such as aluminium, iron, or copper.

The heat-dissipating member 140 may include a heat-dissipating portion 143 that is concavely formed to cover the main body 153 which forms a thick portion of the battery unit 150, and a fixing portion 145 that extends from the heat-dissipating portion 143 to be disposed along with the flange portion 155 of the battery unit 150 between the first and second frame cases 110 and 120. The heat-dissipating member 140 may promote heat dissipation because the main body 153 of the battery unit 150 is covered by the heat-dissipating portion 143 to closely contact the heat-dissipating portion 143, and may be firmly fixed to its position because the fixing portion 155 is tightly disposed between the first and second frame cases 110 and 120.

A cut portion 145′ of the fixing portion 145 of the heat-dissipating member 140 is formed at the side where the first and second lead tabs 151 and 152 extend. Since the heat-dissipating member 140 is preferably formed of a metal material having high thermal conductivity, the cut portion 145′ may be formed in the heat-dissipating member 140 in order to avoid electrical interference with the first and second lead tabs 151 and 152.

The heat-dissipating member 140 may not only promote heat dissipation of the battery unit 150 but also prevent thermal expansion of the battery unit 150. That is, the heat-dissipating member 140 which covers one surface of the battery unit 150 may prevent degradation of electrical characteristics of the battery unit 150 by preventing or inhibiting the battery unit 150 from swelling. In a secondary battery module in which a plurality of the secondary batteries 100 are joined together, since the plurality of secondary batteries 100 are stacked to overlap with one another, the heat-dissipating member 140 may maintain a constant distance between adjacent secondary batteries 100 by preventing swelling and may prevent thermal runaway due to thermal interference between adjacent secondary batteries 100.

A thermistor 160 in FIG. 1 detects temperature information of the battery unit 150. The thermistor 160 may be disposed along with the battery unit 150 between the third side portions 113 and 123 of the first and second frame cases 110 and 120, and may closely contact the battery unit 150.

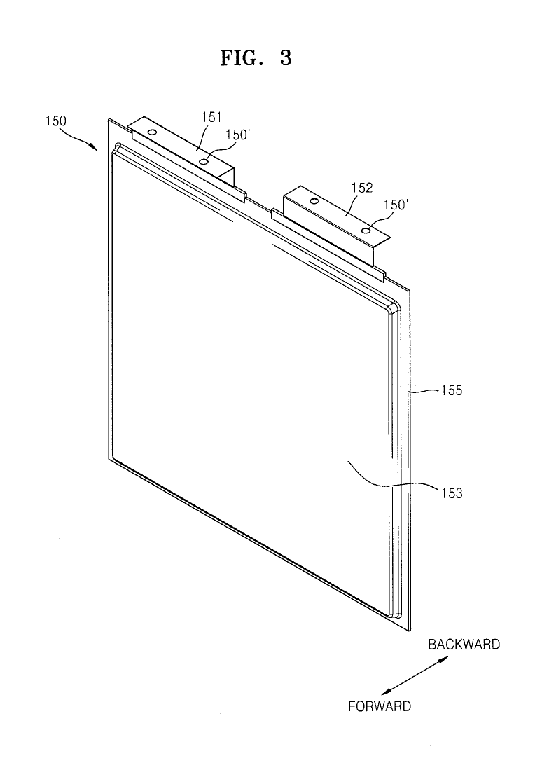

FIG. 3 is a perspective view illustrating the battery unit 150 of the secondary battery 100 of FIG. 1.

Referring to FIG. 3, the battery unit 150 includes the main body 153 and the flange portion 155, and the first and second lead tabs 151 and 152 extending out of the main body 153 and the flange portion 155. The main body 153 includes the electrode assembly therein and forms a relatively thick portion, and the flange portion 155 includes the spare case member which seals the electrode assembly and forms a relatively thin portion.

The main body 153 may correspond to most portions of the battery unit 150, and the flange portion 155 may correspond to an edge formed by outwardly extending the spare case member which seals the electrode assembly. As described below, the main body 153 and the flange portion 155 may be fixed between the first and second frame cases 110 and 120 having substantially quadrangular frame shapes which are assembled to face each other, and the flange portion 155 may be tightly disposed between the first and second frame cases 110 and 120. However, the present embodiment is not limited thereto, and the first and second frame cases 110 and 120 may be fixed by using various portions according to detailed structures of the main body 153 and the flange portion 155 which are modifiable.

The first and second lead tabs 151 and 152 form external interconnections of the main body 153, and extend out of the main body 153 to guide current from the main body 153 to the outside. The first and second lead tabs 151 and 152 may be formed of a metal material having high conductivity, such as nickel, aluminium, or copper. The first and second lead tabs 151 and 152 may have different polarities, and may be respectively electrically connected to a positive plate (not shown) and a negative plate (not shown) of the main body 153. For example, the first lead tab 151 may correspond to a negative tab and the second lead tab 152 may correspond to a positive tab.

In FIG. 3, the first and second lead tabs 151 and 152 having different polarities may be bent in opposite directions. For example, in a secondary battery module in which a plurality of the secondary batteries 100 are electrically joined together, the first lead tabs 151 may be bent forward and the second lead tabs 152 may be bent backward in a direction in which the secondary batteries 100 are arranged.

In the secondary battery module, the plurality of the secondary batteries 100 may be arranged to overlap with one another in parallel, and may be arranged in alternate directions to be connected to one another in series. That is, adjacent secondary batteries 100 may be arranged such that left and right sides of the first and second lead tabs 151 and 152 having different polarities are different from each other, and electrical connection between the adjacent secondary batteries 100 may occur by connecting the first and second lead tabs 151 and 152 of the adjacent secondary batteries 100 which are bent to face each other.

For electrical connection between the secondary batteries 100, coupling holes 150′ may be formed in the first and second lead tabs 151 and 152. For example, the first and second lead tabs 151 and 152 of adjacent secondary batteries 100 may overlap with each other, and electrical connection between the adjacent secondary batteries 100 may occur by using coupling members (not shown) passing through and inserted into the first and second lead tabs 151 and 152. For example, two coupling holes 150′ may be formed in each of the first and second lead tabs 151 and 152.

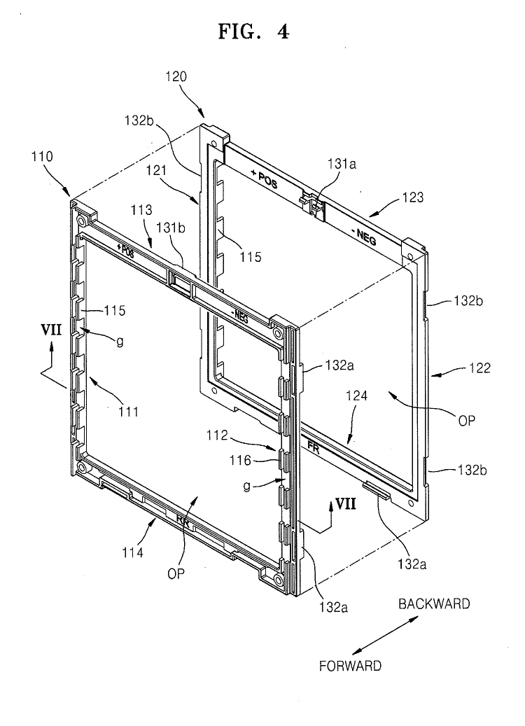

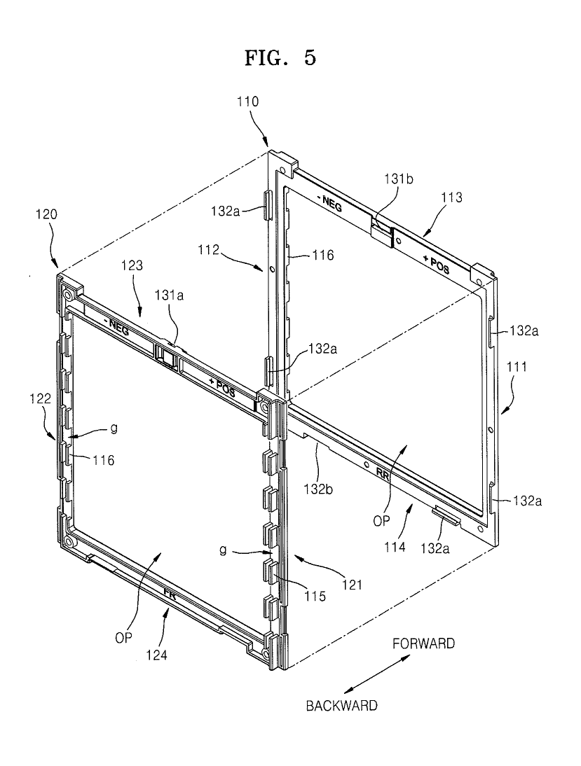

FIG. 4 is a perspective view illustrating the first and second frame cases 110 and 120 of the secondary battery 100 of FIG. 1. FIG. 5 is a perspective view illustrating a state where the first and second frame cases 110 and 120 of FIG. 4 are rotated by 180 degrees.

Referring to FIGS. 4 and 5, the first and second frame cases 110 and 120 may be coupled to each other by coupling members 131a, 131b, 132a, and 132b with the battery unit 150 therebetween, and the battery unit 150 may be supported in a confined state between the first and second frame cases 110 and 120. The coupling members 131a, 131b, 132a, and 132b may be mechanical coupling members complementarily formed at corresponding positions of the first and second frame cases 110 and 120.

For example, the coupling members 131a, 131b, 132a, and 132b may have a hook structure. In detail, the coupling members 131a and 132a having hook shapes may be formed at one side of the first and second frame cases 110 and 120, and the coupling members 131b and 132b which act as stoppers and allow the coupling members 131a and 132a to be inserted thereinto may be formed at the other side of the first and second frame cases 110 and 120. For example, the coupling members 131b and 132b may be grooves or through-holes in which the coupling members 131a and 132a are received.

The coupling members 131a, 131b, 132, and 132b may be formed at one or more places along the first and second frame cases 110 and 120, to firmly compress and fix the battery unit 150. The coupling members 131a, 131b, 132a, and 132b formed at the plurality of places may provide uniform coupling forces along an edge of the battery unit 150. For example, the coupling members 131a, 131b, 132a, and 132b may be formed on the first through fourth side portions 111, 112, 113, 114, 121, 122, 123, and 124. In the coupling members 131a, 131b, 132a, and 132b, the coupling members 131a and 132a and the coupling members 131b and 132b which face each other form pairs.

For example, the coupling members 131a and 131b are formed on the first side portions 111 and 121, wherein the coupling member 131a has a hook shape and protrudes from the second frame case 120 toward the first frame case 110, and the coupling member 131b acts as a stopper and is formed on the first frame case 110 to face the coupling member 131a. As the first and second frame cases 110 and 120 are attached to each other to face each other, the coupling member 131a may be deformed to receive the coupling member 131b, elastically restored, and coupled to the coupling member 131b. For example, the coupling member 131a formed on the second frame case 110 by cutting a portion of a main body of the second frame case 120 may be more flexibly deformed to receive the coupling member 131b, thereby making a process of coupling the first and second frame cases 110 and 120 easier. <

Since the first and second frame cases 110 and 120 are assembled by using the coupling members 131a, 131b, 132a, and 132b formed on the first and second frame cases 110 and 120, an additional fastening structure such as a tape or a screw is not required, thereby simplifying an assembling process and improving processability.

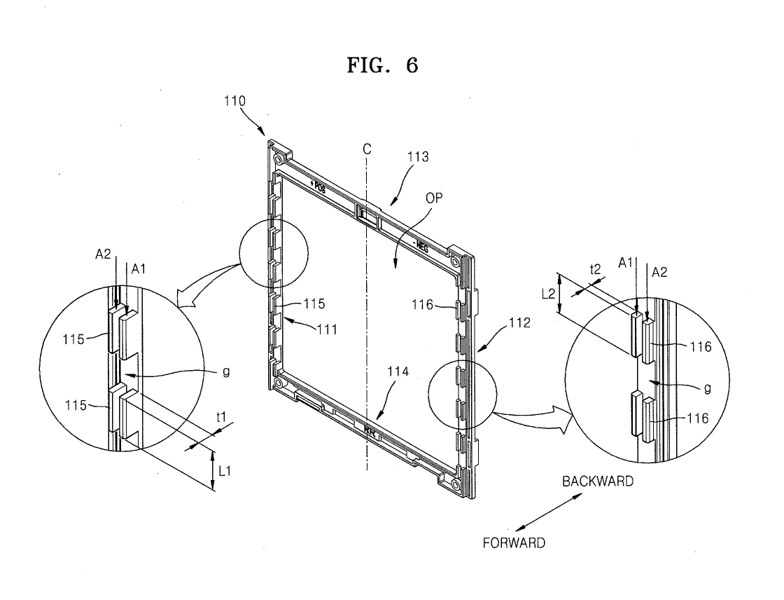

FIG. 6 is an enlarged perspective view illustrating the first frame case 110 of FIG. 4.

Referring to FIG. 6, the first and second spacers 115 and 116 may be formed on the first frame case 110. For example, the first and second spacers 115 and 116 may integrally protrude from the first frame case 110. The first and second spacers 115 and 116 may protrude substantially perpendicularly (corresponding to a frontward direction) to a main surface of the first frame case 110 when the first frame case 110 has a substantially plate shape.

The first and second spacers 115 and 116 may elongate to predetermined lengths L1 and L2 on the first frame case 110, and may protrude forward to predetermined thicknesses t1 and t2 from the first frame case 110.

The first and second spacers 115 and 116 may extend along the first frame case 110 intermittently, rather than continuously, and may include a plurality of sub-members having isolated shapes. The first and second spacers 115 and 116 may be intermittently arranged at a predetermined gap ‘g’, and the gap ‘g’ functions as an airflow passage.

The first and second spacers 115 and 116 may be arranged in two or more columns along side portions, for example, the first and second side portions 111 and 112, of the first frame case 110. In FIG. 6, the first and second spacers 115 and 116 may be arranged in first and second columns A1 and A2 along the first and second side portions 111 and 112, and the first and second spacers 115 and 116 may be arranged at the gap ‘g’, in order to prevent an airflow passage formed in the gap ‘g’ from being blocked and allow the airflow passage to pass through the first frame case 110.

The first and second spacers 115 and 116 may be respectively formed on the first and second side portions 111 and 112 of the first frame case 110. The first and second spacers 115 and 116 may be respectively formed on the first and second side portions 111 and 112 which are left and right side portions of the first frame case 110, and may have different shapes. The first and second spacers 115 and 116 extend out of the battery unit 150 through different positions, that is, left and right positions on the third side portion 113 of the first frame case 110.

Since the first and second spacers 115 and 116 are formed on the first and second side portions 111 and 112 which are left and right side portions, to have different shapes, positions where the first and second lead tabs 151 and 152 are assembled may be easily managed. For example, in a secondary battery module in which a plurality of the secondary batteries 100 are joined together, the secondary batteries 100 may be appropriately connected by aligning the positions where the first and second lead tabs 151 and 152 extending out of the secondary batteries 100 are assembled.

The first and second spacers 115 and 116 which are formed on the first and second side portions 111 and 112 which face each other on the first frame case 110 and have different dimensions may provide a misassembly-preventing mechanism. For example, in a secondary battery module in which the plurality of secondary batteries 100 are electrically joined together, the plurality of secondary batteries 100 may be alternately arranged such that left and right sides are different from each other for the purpose of electrical connection (for example, serial connection).

In such an arrangement of the secondary batteries 100, since the first and second lead tabs 151 and 152 are located adjacent to each other in a frontward and backward direction, a serial connection between the first and second lead tabs 151 and 152 may be achieved. However, if orientations of adjacent secondary batteries 100 are mixed and thus misassembly occurs, normal charging and discharging operations may not occur due to a connection error between the secondary batteries 100, thereby leading to an unexpected accident. For example, the secondary batteries 100, which are arranged in a frontward and backward direction, may fail to form a serial connection and may partially form a parallel connection, thereby resulting in unstable connection.

The first and second spacers 115 and 116 having different shapes may have asymmetric dimensions. That is, the first and second spacers 115 and 116 which are formed on opposite left and right sides have asymmetric dimensions about a central axis C of the first frame case 110. Here, the term ‘dimensions’ refers to sizes of outer shapes of the first and second spacers 115 and 116. In detail, the dimensions may denote the lengths L1 and L2, the thicknesses t1 and t2, or widths. For example, the first and second spacers 115 and 116 may have the different thicknesses t1 and t2, and the thickness t1 may be greater than the thickness t2 (t1>t2).

As described below, in order to form a misassembly-preventing mechanism, adjacent secondary batteries 100 are assembled to contact each other through the first and second spacers 115 and 116. Accordingly, the first and second spacers 115 and 116 may be formed at symmetric positions about the central axis C of the first frame case 110 to overlap with each other.

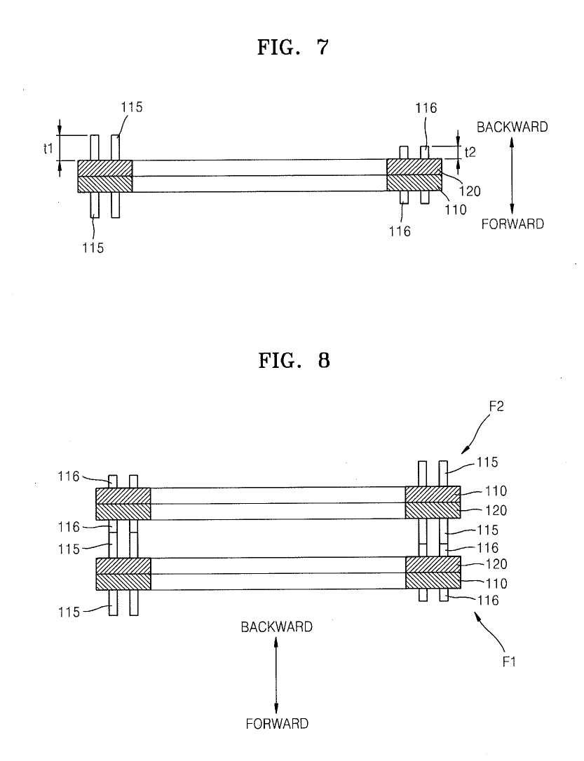

FIG. 7 is a cross-sectional view taken along line VII-VII of FIG. 4.

Referring to FIG. 7, the first and second spacers 115 and 116 may be formed on the first and second frame cases 110 and 120, and may be formed on opposite outer surfaces of the first and second frame cases 110 and 120, and may protrude in a frontward and backward direction. For example, the first spacer 115 may be formed on a left side of the first and second frame cases 110 and 120, and the second spacer 116 may be formed on a right side of the first and second frame cases 110 and 120. However, the present embodiment is not limited thereto, and the first and second spacers 115 and 116 may be formed on any sides as long as orientations of adjacent secondary batteries 100 may be detected.

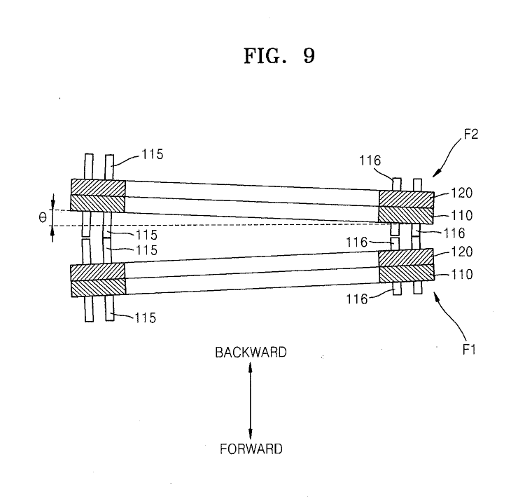

FIGS. 8 and 9 are cross-sectional views for explaining a misassembly-preventing mechanism provided by the first and second spacers 115 and 116 in a secondary battery module in which a plurality of the secondary batteries 100 are joined together. As shown in FIG. 8, if adjacent secondary batteries 100 (specifically, the first and second frame cases 110 and 120) are assembled to have appropriate orientations, that is, if the first and second frame cases 110 and 120 which are adjacent to each other in a frontward and backward direction are assembled such that left and right sides are different from each other, the first spacer 115 of a previous frame case F1 and the second spacer 116 of a next frame case F2 contact each other, and the previous and next frame cases F1 and F2 are stacked horizontally. That is, the first and second spacers 115 and 116 contact each other on both left and right sides of the previous and next frame cases F1 and F2, and the previous and next frame cases F1 and F2 are stacked horizontally while maintaining the same distance therebetween on both the left and right sides.

As shown in FIG. 9, if adjacent secondary batteries 100 (specifically, the first and second frame cases 110 and 120) are assembled to have inappropriate orientations, that is, if the secondary batteries 100 which are adjacent to each other in a frontward and backward direction are assembled such that left and right sides are not different from each other, the first spacer 115 of the previous frame case F1 and the first spacer 115 of the next frame case F2 contact each other on any one of left and right sides, and the second spacer 116 of the previous frame case F1 and the second spacer 116 of the next frame case F2 contact each other on the other side. As a result, the previous and next frame cases F1 and F2 are stacked while being inclined to any one of the left and right sides.

For example, since the first spacers 115 contacting each other on one side have a relatively long distance and the second spacers 116 contacting each other on the other side have a relatively short distance, the previous and next frame cases F1 and F2 are inclined. For example, as shown in FIGS. 8 and 9, while the previous frame case F1 is horizontally disposed, the next frame case F2 may be inclined at an angle θ with respect to a horizontal line.

Referring to FIGS. 8 and 9, due to the misassembly-preventing mechanism provided by the first and second spacers 115 and 116, whether the secondary batteries 100 are mis-assembled may be easily detected. That is, if the secondary batteries 100 are horizontally stacked, it means that orientations of the secondary batteries 100 are appropriate and an operation is normally performed. However, if the secondary batteries 100 are inclined, it means that the secondary batteries 100 are mis-assembled, and thus orientations of the secondary batteries 100 need to be checked and an operation may be performed again.

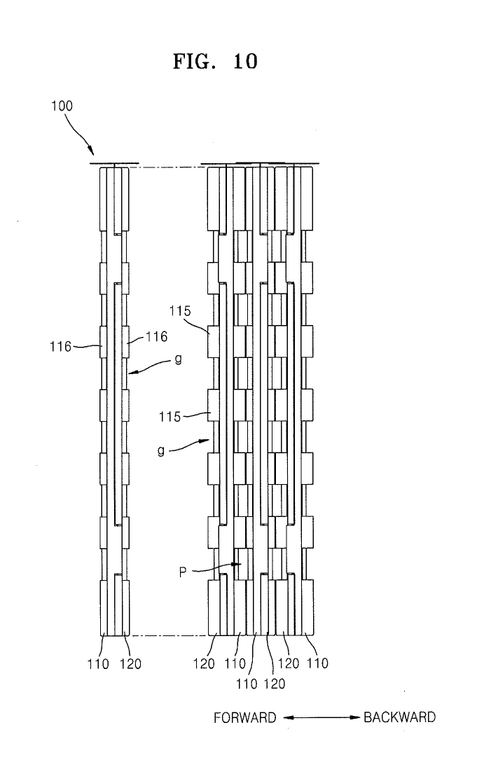

FIG. 10 is a side perspective view of a secondary battery module in which a plurality of the secondary batteries 100 are stacked in a frontward and backward direction, for explaining an airflow passage 10.

Referring to FIG. 10, the first and second spacers 115 and 116 may be used to form an airflow passage P between adjacent secondary batteries 100. In detail, in the secondary battery module in which the plurality of secondary batteries 100 are electrically joined together, the airflow passage P may be formed when the first and second spacers 115 and 116 protruding from the secondary batteries 100 which are stacked adjacent to each other contact each other.

For example, the first and second spacers 115 and 116 of adjacent secondary batteries 100 may contact each other to form the airflow passage P therebetween, and heat may be discharged through the airflow passage P, thereby promoting heat dissipation of the secondary batteries 100. For example, external low-temperature air introduced through the airflow passage P may directly contact the battery unit 150 or the heat-dissipating member 140 exposed to the outside through the opening OP of the first and second frame cases 110 and 120, thereby performing heat transfer and promoting heat dissipation of the battery unit 150.

As shown in FIG. 10, the first and second spacers 115 and 116 of adjacent secondary batteries 100 may contact each other, and external low-temperature air may be introduced through the gap ‘g’ between the first and second spacers 115 and 116 which are intermittently formed. For example, the first and second spacers 115 and 116 may be formed to face each other, and may form the airflow passage P through the gap ‘g’ at which the first and second spacers 115 and 116 facing each other are arranged.

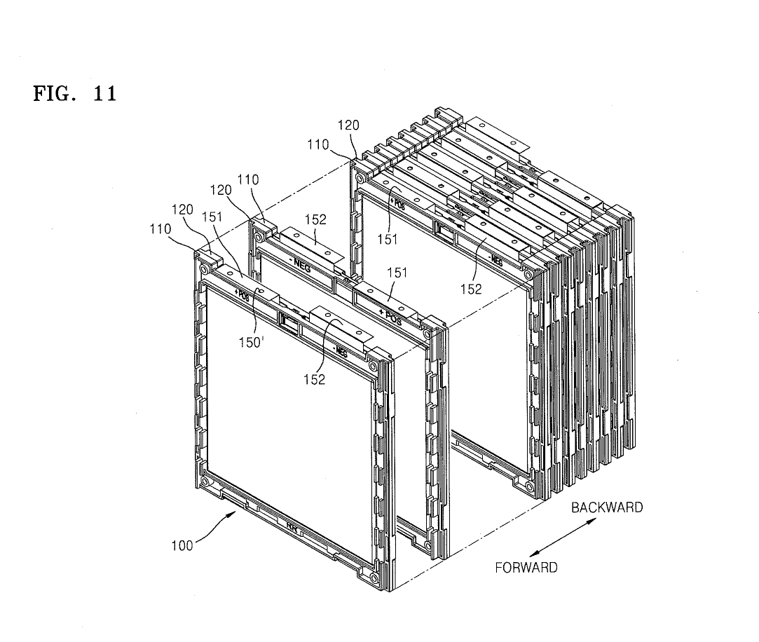

FIG. 11 is an exploded perspective view illustrating a secondary battery module in which a plurality of the secondary batteries 100 of FIG. 2 are electrically joined together, according to an embodiment of the present invention. For example, in order to provide a high-power and high-capacity secondary battery module, the plurality of secondary batteries 100 which are stacked parallel to one another and arranged in one direction may be electrically joined together.

As shown in FIG. 11, the first and second lead tabs 151 and 152 extending out of each of the secondary batteries 100 are bent alternately in a frontward and backward direction in which the secondary batteries 100 are arranged. The first and second lead tabs 151 and 152 bent from a first secondary battery 100 overlap with the first and second lead tabs 151 and 152 bent from a second secondary battery 100 adjacent to the first secondary battery 100.

For example, the first lead tab 151 bent forward from the first secondary battery 100 may overlap with the second lead tab 152 bent backward from the second secondary battery 100 on a front side, and the first and second lead tabs 151 and 152 overlapping with each other may electrically connect the first and second secondary batteries 100 which are arranged adjacent to each other in the frontward and backward direction. The first and second lead tabs 151 and 152 may be the lead tabs 151 and 152 having different polarities, and the first and second secondary batteries 100 which are arranged in the frontward and backward direction may form a serial connection therebetween when their first and second lead tabs 151 and 152 having different polarities are connected to each other.

Likewise, the second lead tab 152 bent backward from the first secondary battery 100 may overlap with the first lead tab 151 bent forward from the second secondary battery 100 on a back side, and the first and second secondary batteries 100 in the frontward and backward direction may be connected to each other through their first and second lead tabs 151 and 152 overlapping with each other.

For example, two coupling holes 150′ may be formed in each of the first and second lead tabs 151 and 152 of adjacent secondary batteries 100 which overlap with each other, and electrical connection may occur due to coupling members (not shown) inserted into the coupling holes 150′.

In the secondary battery module shown in FIG. 11, the secondary batteries 100 which are arranged in the frontward and backward direction are alternately disposed to form a serial connection therebetween. However, the secondary battery module may be configured in various modified manners, and for example, may be configured to form a parallel connection or a combination of a parallel connection and a serial connection.

When a plurality of secondary batteries are electrically joined together to constitute a module by using spacers having asymmetric shapes, a misassembly-preventing mechanism may enable the secondary batteries arranged in a frontward and backward direction to be assembled to have appropriate orientations and may easily detect abnormal orientations. Also, since an airflow passage is formed by using the spacers, heat dissipation of the secondary batteries may be promoted.

While the present invention has been particularly shown and described with reference to exemplary embodiments thereof using specific terms, the embodiments and terms have been used to explain the present invention and should not be construed as limiting the scope of the present invention defined by the claims. Accordingly, it will be understood by those of ordinary skill in the art that the spirit and scope of the present invention are defined by the following claims.

What is claimed is:

1. A secondary battery comprising:
a battery unit; and
a frame case that supports the battery unit and has a first side portion and a second side portion which are opposite to each other and on which first and second spacers are respectively formed, wherein the first and second spacers have asymmetric dimensions.

2. The secondary battery of claim 1, wherein the first and second spacers protrude perpendicularly to a main surface of the frame case.

3. The secondary battery of claim 1, wherein the first and second spacers protrude to different thicknesses from the frame case.

4. The secondary battery of claim 1, wherein the frame case supports the battery unit due to the frame case having a frame shape extending along an edge of the battery unit.

5. The secondary battery of claim 1, wherein a plurality of sub-members of the first and second spacers are arranged to have isolated shapes along the opposite first and second side portions of the frame case.

6. The secondary battery of claim 1, wherein the first and second spacers are arranged in two or more columns along each of the first and second side portions.

7. The secondary battery of claim 1, wherein the battery unit comprises a main body, and first and second lead tabs extending out of the main body, wherein the first and second lead tabs extend to the outside through a third side portion of the frame case.

8. The secondary battery of claim 7, wherein the first and second spacers are respectively formed on the first and second side portions of the frame case adjacent to the third side portion of the frame case.

9. The secondary battery of claim 1, wherein the frame case comprises first and second frame cases that are coupled to each other to face each other with the battery unit between the first and second frame cases.

10. The secondary battery of claim 9, wherein the first and second frame cases are formed to have frame shapes that hold an edge of the battery unit.

11. The secondary battery of claim 10, wherein each of the first and second frame cases comprises an opening through which a central portion of the battery unit is exposed.

12. The secondary battery of claim 9, wherein first and second spacers having asymmetric dimensions are disposed on opposite sides of the first frame case, and first and second spacers having asymmetric dimensions are disposed on opposite sides of the second frame case.

13. The secondary battery of claim 9, further comprising a heat-dissipating member that is disposed along with the battery unit between the first and second frame cases.

14. A secondary battery module comprising a plurality of secondary batteries that are arranged adjacent to one another,
wherein each of the plurality of secondary batteries comprises:
a battery unit; and
a frame case that supports the battery unit and has a first side portion and a second side portion which are opposite to each other and on which first and second spacers are respectively formed,
wherein the first and second spacers have asymmetric dimensions.

15. The secondary battery module of claim 14, wherein the first and second spacers protrude to different thicknesses from the frame case.

16. The secondary battery module of claim 14, wherein the first spacer and the second spacer are assembled to contact each other between adjacent secondary batteries.

17. The secondary battery module of claim 16, wherein the first and second spacers contacting each other form an airflow passage.

18. The secondary battery module of claim 14, wherein the frame case is formed to have a frame shape that holds an edge of the battery unit, and comprises an opening through which a central portion of the battery unit is exposed.

19. A secondary battery module comprising:
a battery unit
a first frame and a second frame that are positioned about the periphery of the battery unit, wherein the first frame and the second frame have first and second side surfaces that extend outward from the periphery of the battery unit and face each other;
first protrusions that extend outward from the first side of the first frame a first distance;
second protrusions that extend outward from the first side of the second frame a second distance so as to engage with the first protrusions wherein the first and second protrusions define a first total distance;
third protrusions that extend outward from the second side of the first frame a third distance different than the first distance;
fourth protrusions that extend outward from the second side of the second frame a fourth distance different than the second distance so as to engage with the third protrusions wherein the third and fourth protrusions define a second total distance that is substantially equal to the first total distance.

20. The battery module of claim 19, wherein the first and second protrusions and the third and fourth protrusions define air flow gaps between the first and second frame.
